(19) United States
(12) Patent Application Publication
(10) Pub. No.: US 2015/0004303 A1
(43) Pub. Date: Jan. 1, 2015

(54) COCOA POWDER AND PROCESSES FOR ITS PRODUCTION

(71) Applicant: Mondelez UK R&D Limited, Birmingham (GB)

(72) Inventors: Pawel Gaca, Birmingham (GB); Joel Gawler, Birmingham (GB)

(21) Appl. No.: 14/377,154

(22) PCT Filed: Sep. 28, 2012
(86) PCT No.: PCT/GB2012/052416

§ 371 Date: Aug. 6, 2014

(30) Foreign Application Priority Data
Feb. 27, 2012 (GB) 1203360.1

(51) Int. Cl. A23G 1/32

(52) U.S. Cl. CPC A23G 1/325; A23V 2002/00
USPC 426/631

(57) ABSTRACT

A process for the production of black cocoa powder comprises an alkalization step in which an alkalizing salt is added to cocoa beans, or products derived therefrom, in the absence of iron. The alkalizing salt may be ammonium, calcium, magnesium, potassium or sodium carbonate, ammonium, potassium or sodium bicarbonate, ammonium, calcium, magnesium, potassium or sodium hydroxide, magnesium oxide or any combination thereof. Cocoa powder resulting from the process, and products comprising the cocoa powder, are also described.

The present invention relates to improved processes for the production of cocoa powder. It also relates to cocoa powder made thereby and products comprising cocoa powder.

### BACKGROUND OF THE INVENTION

Cocoa, including cocoa liquor and cocoa powder (cocoa solids), is the essential ingredient of chocolate and other sweet and savoury foods having a chocolate-like flavour such as biscuits, desserts and beverages. Cocoa powder is the solid, “non-fat” (conventionally 10-12 or 20-22 wt. % fat) component of cocoa liquor which is obtained by fermenting, de-shelling, roasting, grinding and pressing cocoa beans and grinding the resulting cocoa cake (the other component of cocoa liquor being cocoa butter).

In the manufacture of cocoa, steaming and alkalization may be included. The steaming step may be included prior to the roasting, and prior to alkalization, for the purpose of debacterizing the cocoa beans as received after fermentation. Alternatively, the steaming or wetting step introduces water into the cocoa beans or nibs, making them more flexible to withstand the roasting without mechanical damage.

The alkalization in general is employed for several purposes. On the one hand, it produces a broad variety of differently coloured cocoa powders for specific applications. On the other hand, it increases the pH of the product, rendering it more soluble in an aqueous surrounding, which is important if the product is dispersed, e.g., in a beverage. Finally, the alkalization may improve the flavour of the final cocoa.

Both the alkalization and the roasting step can be applied on the cocoa bean, on the cocoa nib after removal of the shell, on the cocoa liquor, on the cocoa cake after pressing off the cocoa butter, or on the cocoa powder after pulverization of the cocoa cake. Also, the sequence of the roasting and alkalization may be changed, depending on equipment and functionality of the finished product.

High flavour cocoa (HFC) powder and ‘standard’ black cocoa powder are types of dark-coloured cocoa powder which are used in confectionery items such as biscuits, for example Oreos. Standard black cocoa powder has a dark brown/black colouration, while HFC is a powder that has been roasted in a particular way to give a more intense flavour. The dark colour of both types of powders is produced by the chemicals used in the alkalization. In current processes, iron saccharate and ammonium carbonate are added in a dry form with sodium hydroxide being added as a solution at a different stage of the process. However, the use of ammonium carbonate causes a number of challenges in both the personal safety of those producing the powder and in terms of environmental impact due to the liberation of ammonia gas through the process. Specialist handling and waste treatment facilities are therefore required at sites producing HFC powder through this process. In a number of markets globally, the use of certain iron salts in the production of cocoa powders is forbidden from a regulatory standpoint.

The present invention aims to mitigate some or all of the problems identified above.

### SUMMARY OF THE INVENTION

According to a first aspect of the present invention, there is provided a process for the production of black cocoa powder, said process comprising an alkalization in which an alkalizing salt is added to cocoa beans, or products derived therefrom, in the absence of iron.

Since cocoa powders made with iron salts are not approved for use in certain countries, the elimination of the use of iron salts in the production of black cocoa powder will allow the manufacture and sale of confectionery products comprising that powder in a wider number of countries.

A black cocoa powder is a cocoa powder that is produced by a process which includes alkalization, and which usually has a darker colour than cocoa powders derived without alkalization. One way to measure the degree of lightness or darkness of cocoa powder is by using the Hunter “L” scale value. The Hunter L scale was designed to give measurements of colour units of approximate visual uniformity. Thus “L” measures lightness and varies for 0 for pure black to 100 for pure white. Commercial deep red cocoa powders typically have an “L” value of 19 to 24. The colour scales are described more fully in Hunter, R. S., The Measurement of Appearance, John Wiley and Sons, New York, 1975.

The colour of cocoa powder, and other food and beverage products, can additionally be defined using the parameters “a” and “b”. “a” represents the red-green scale, wherein a positive “a” value indicates red while a negative “a” value indicates green. “b” represents the yellow-blue scale, wherein a positive “b” value indicates yellow while a negative “b” value indicates blue. In each case, the higher the numerical value, the more intensive the colour impression. The method utilized for colour measurement can be carried out using dry powder, or using a suspension of cocoa powder in water which is known as “intrinsic colour”. For measurement of the colour of the dry powder, the cocoa powder sample to be tested is thoroughly mixed, then transferred into a glass cuvette. The sample in the cuvette is compressed with the help of a stamp so that the cuvette is homogeneously filled and no light passes through. The colour values “L”, “a” and “b” are then immediately measured using a spectrocolorimeter with illumination from the side (e.g. HunterLab Colour Quest, measurement in RSEX mode, excluding gloss). The spectrocolorimeter should be calibrated before use according to the instruction manual. In the “intrinsic colour” test, 40 g of cocoa powder is dispersed in 120 ml de-ionized water (60° C.±3° C.) and stirred with a spatula to ensure homogeneity. The suspension is cooled to room temperature and stirred again. The dispersion is immediately poured into a cuvette and the colour values are measured using a spectrocolorimeter after 1 minute. At least two replicate measurements should be carried out per sample.

A black cocoa powder, as referred to herein, is understood to have an “L” value (as measured in accordance with the method described above) of less than 16, less than 14, less than 12, less than 9, less than 6 or less than 4.

As used herein, “cocoa beans or products derived therefrom” will be understood to include, cocoa nibs, cocoa liquor or cocoa cake (derived by pressing off the cocoa butter from cocoa liquor). In certain embodiments of the first aspect of the invention, the alkalization is carried out on cocoa beans or cocoa nibs.

The following paragraphs relating to the alkalizing salt (also known in the art as an alkalizing agent) relate to all aspects of the invention, unless it is stated otherwise.

As will be appreciated by those skilled in the art, the alkalization (also referred to as “alkalizing”) will comprise the addition of an alkalizing salt to the cocoa beans or products derived therefrom. In some embodiments, the alkalizing salt is selected from ammonium, calcium, magnesium, potassium or sodium carbonate, ammonium, potassium or sodium bicarbonate, ammonium, calcium, magnesium, potassium or sodium hydroxide, magnesium oxide or any combination thereof. In a particular embodiment, the alkalizing salt is selected from ammonium carbonate, sodium hydroxide, potassium hydroxide or any combination thereof. In another embodiment, the alkalizing salt consists of a mixture of ammonium carbonate, sodium hydroxide and potassium hydroxide.

Alkalizing salts may be added to the cocoa beans or products derived therefrom in, the form of an aqueous solution, having a concentration of from 1% (w/v) to saturation, typically from 10 to 50% (w/v), from 15 to 35% (w/v), or from 20 to 25% (w/v). Alkalizing salts such as ammonium carbonate may also be used in solid (dry) form. The amount of alkalizing salt will depend inter alia on its basicity, the desired alkalization level and the associated colour and colour intensity. The total amount of alkalizing salts added may range from 1 to 20 wt %, from 3 to 18 wt % or from 5 to 15 wt % based on the weight of the cocoa beans or products derived therefrom.

In embodiments wherein the alkalizing salt comprises ammonium carbonate, the amount, of ammonium carbonate added to the cocoa beans or products derived therefrom is at least 2 wt %, at least 5 wt %, at least 8 wt %, at least 10 wt % or at least 12 wt %, based on the weight of the cocoa beans or products derived therefrom. In other embodiments, the amount of ammonium carbonate added is no more than 20 wt %, no more than 15 wt %, no more than 13 wt % or no more than 10 wt %, based on the weight of the cocoa beans or products derived therefrom.

In some embodiments, the alkalizing salt does not contain an ammonium salt, i.e. the alkalization is carried out in the absence of an ammonium salt.

In some embodiments of the first aspect of the invention, the alkalizing salt comprises or consists of a potassium salt. The alkalizing salt may comprise or consist of potassium hydroxide, potassium carbonate or potassium bicarbonate. In some embodiments of the first aspect of the invention, the alkalizing salt comprises or consists of potassium hydroxide. In some embodiments, the alkalizing salt comprises or consists of potassium carbonate. Advantageously, the use of potassium salts allows the amount of sodium salts to be reduced or eliminated altogether. The total amount of potassium salts added to the cocoa beans or products derived therefrom may be at least 1 wt %, at least 2 wt %, at least 5 wt % or at least 10 wt %. The total amount of potassium salts added to the cocoa, beans or products derived therefrom may be no more than 20 wt %, no more than 15 wt %, no more than 12 wt %, no more than 10 wt %, no more than 8 wt % or no more than 5 wt %.

Potassium hydroxide also conveniently imparts colouring to the resultant cocoa powder and thus it can replace or eliminate the use of iron salts as colourants. The amount of potassium hydroxide added to the cocoa beans or products derived therefrom may be at least 1 wt %, at least 2 wt %, at least 3 wt %, at least 4 wt % or at least 5 wt %. The amount of potassium hydroxide added to the cocoa beans or products derived therefrom may be no more than 10 wt %, no more than 8 wt %, no more than 5 wt % or no more than 4 wt %, based on the weight of the cocoa beans or products derived therefrom.

In embodiments wherein the alkalizing salt comprises or consists of potassium carbonate, the amount of potassium carbonate added to the cocoa beans or products derived therefrom is from is at least 2 wt %, at least 3 wt %, at least 4 wt %, at least 5 wt %, or at least 7 wt %, based on the weight of the cocoa beans or products derived therefrom. The amount of potassium carbonate may be no more than 16 wt %, no more than 14 wt %, no more than 12 wt %, no more than 10 wt % or no more than 8 wt %. In some embodiments, the amount of potassium carbonate is from 5 wt % to 10 wt %.

In some embodiments, the alkalizing salt comprises or consists of sodium hydroxide. The amount of sodium hydroxide added to the cocoa beans or products derived therefrom may be more than 2 wt %, more than 2.5 wt %, more than 3 wt %, more than 3.5 wt %, more than 4 wt % or more than 5 wt %, based on the weight of the cocoa beans or products derived therefrom. The amount of sodium hydroxide added to the cocoa beans or products derived therefrom may be less than 12 wt %, less than 10 wt %, less that 8 wt %, less than 5 wt %, less than 4 wt % or less than 3 wt %. The alkalizing salt may comprise or consist of 2.4 wt % sodium hydroxide.

In an embodiment, the alkalizing salt comprises sodium hydroxide and potassium carbonate. The amount of potassium carbonate added to the cocoa beans or products derived therefrom may be more than 2 wt %, more than 2.5 wt %, more than 3 wt %, more than 3.5 wt %, more than 4 wt % or more than 5 wt %, based on the weight of the cocoa beans or products derived therefrom. The amount of sodium hydroxide may be more than 2 wt %.

In some embodiments, the alkalizing salt consists of sodium hydroxide and potassium carbonate. The amount of sodium hydroxide added to the cocoa beans or products derived therefrom may be more than 1 wt %, more than 2 wt %, more than 2.5 wt %, more than 3 wt %, more than 4 wt % or more than 5 wt %, based on the weight of the cocoa beans or products derived therefrom. The amount of potassium carbonate may be more than 2 wt %, more than 3 wt %, more than 4 wt %, more than 5 wt % or more than 7 wt %. In an embodiment, the amount of sodium hydroxide is more than 2 wt % and the amount of potassium carbonate is from 2 to 16 wt %, from 3 to 14 wt %, from 4 to 12 wt % or from 5 to 10 wt %. In an embodiment, the amount of sodium hydroxide is 2.4 wt % and the amount of potassium carbonate is from 5 to 10 wt %. In an embodiment, the amount of sodium hydroxide is more than 1 wt % and the amount of potassium carbonate is more than 2 wt %. In some embodiments, the amount of potassium carbonate is less than 1 wt %, less than 0.8 wt % or less than 0.6 wt %, for example 0.5 wt %. For example, the amount of sodium hydroxide may be more than 1 wt % or more than 2 wt %, and the amount of potassium carbonate may be less than 1 wt %. In an embodiment, the amount of sodium hydroxide is 2.4 wt % and the amount of potassium carbonate is 0.5 wt %.

In some embodiments, the alkalizing salt consists of sodium hydroxide and ammonium carbonate. The amount of sodium hydroxide added to the cocoa beans or products derived therefrom may be from 1 to 4 wt %, from 1.5 to 3.5 wt %, from 1.7 to 3.0 wt % or from 2.0 to 2.5 wt %, for example 2.4 wt %. The amount of ammonium carbonate added to the cocoa beans or products derived therefrom may be from 1 to 15 wt %, from 3 to 12 wt %, from 4 to 10 wt % or from 5 to 7 wt %. For example, the amount of sodium hydroxide may be from 1 to 4 wt % and the amount of ammonium carbonate may be from 5 to 7 wt %.

In some embodiments, the alkalizing salt consists of sodium hydroxide, potassium carbonate and ammonium carbonate. The amount of sodium hydroxide added to the cocoa beans or products derived therefrom may be from 1 to 4 wt %, from 1.5 to 3.5 wt %, from 1.7 to 3.0 wt % or from 2.0 to 2.5 wt %, for example 2.4 wt %. The amount of ammonium carbonate added to the cocoa beans, or products derived therefrom may be from 1 to 15 wt %, from 3 to 12 wt %, from 4 to 10 wt % or from 5 to 7 wt %. The amount of potassium carbonate added to the cocoa beans or products derived therefrom may be from 0.3 to 5 wt %, from 0.5 to 2 wt %, or from 0.8 to 1.5 wt %, for example 1 wt %.

In some embodiments, the process is for the production of a black cocoa powder having an “L” value of less than 10, less than 5, less than 4, less than 3.5, less than 3 or less than 2, wherein the alkalizing salt is selected from:

an alkalizing salt consisting of ammonium carbonate and sodium hydroxide;
an alkalizing salt consisting of sodium hydroxide;
an alkalizing salt consisting of potassium carbonate and sodium hydroxide;
an alkalizing salt consisting of sodium hydroxide, ammonium carbonate and potassium hydroxide;
an alkalizing salt consisting of sodium hydroxide and potassium hydroxide; or
an alkalizing salt consisting of sodium hydroxide, potassium hydroxide and potassium carbonate.

Thus according to a second aspect of the present invention, there is provided a process for the production of cocoa powder, said process comprising an alkalization in which an alkalizing salt is added to cocoa beans or products derived therefrom, wherein sodium hydroxide is added as the sole alkalizing salt in an amount which is more than 2 wt %, based on the weight of the cocoa beans or products derived therefrom.

The following paragraphs relating to the processing of cocoa beans or products derived therefrom relate equally to the first, second or third aspects of the invention, unless stated otherwise.

The alkalization may be carried out in a closed vessel under heating and/or pressure. In a particular embodiment, the alkalization is carried out in a stirred pressurized mixer with jacket heating and direct steam injection. In particular, a cocoa nib alkalizer as is conventionally known in the industry may be used, e.g. from Barth or Mitchell or Drais. The temperature within the vessel or mixer may be from 50° C. to 200° C., from 70° C. to 180° C., from 80° C. to 160° C. or from 90° C. to 150° C. In an embodiment, the temperature within the vessel or mixer is held constant (e.g. at approximately 95° C.) while the cocoa beans or products derived therefrom, and the alkalizing agent, are added. The temperature and pressure within the vessel or mixer may then be increased for a period of time. This is referred to as the pressurisation phase. The temperature within the vessel or mixer during the pressurisation phase may be from 100 to 200° C. or from 120 to 180° C. In some embodiments, the temperature during the pressurisation phase is from 136 to 148° C., from 137 to 145° C. or from 138 to 143° C., for example 140° C. The pressure in the vessel or mixer during pressurisation phase may be at least 1.0 bar, at least 2.0 bar, at least 2.5 bar, at least 3.0 bar or at least 3.5 bar. The pressure may be no more than 5.0 bar, no more than 4.5 bar, no more than 4.0 bar or no more than 3.0, bar. In some embodiments, the pressure during pressurisation phase is 2.5 bar. In some embodiments, the pressure is from 3.2 to 4.5 bar or from 3.5 to 4.0 bar. The pressurisation phase may be carried out for a period of time of from 30 to 150 minutes, from 60 to 120 minutes or from 80 to 100 minutes. In an embodiment, pressurisation phase is carried out for 90 minutes.

The alkalization may include a pre-treatment step in which the cocoa beans or products derived therefrom are heated in the presence of water or steam, optionally under pressure, for a period of time. It has been found that this pre-treatment prepares the cocoa beans or products derived therefrom for and improves the penetration and incorporation of alkali. As a result, less alkali and a reduced alkalization time may be required. Thus, in a preferred embodiment, the pre-treatment step is carried out prior to the addition of the alkalizing agent to the cocoa beans or products derived therefrom. Pre-treatment may be carried out at a temperature of from 80 to 100° C., or from 90 to 97° C. Pre-treatment may be carried out at 95° C. In an embodiment, the pre-treatment is carried out in a stirred mixer with a jacket heating. Pre-treatment may be carried out for a period of time of from 30 to 120 minutes, from 45 to 100 minutes or from 50 to 70 minutes. In an embodiment, pre-treatment is carried out for 60 minutes.

Alternatively, the pre-treatment can be carried out by adding steam at a pressure of from 2 to 4 bar, such as 2 bar, as received from conventional wet steam on-site production facilities. The steaming can be carried out for, e.g., 15 minutes, depending on the batch size to achieve full wetting of the cocoa beans or nibs. For example, at a batch size of 1,800 kg, a steaming time of 15 minutes may be necessary, whereas a steaming time of 2 minutes may suffice for a batch size of 15 kg. In the pre-treatment with steam, the equipment may be a stirred mixer with jacket heating and a means for direct steam injection, for example a cocoa nib alkalizer conventionally known in the industry, e.g. from Barth or Mitchell.

In some embodiments, the alkalization includes an aeration (also referred to as “air injection”) step, in which an oxygen-containing gas such as air is supplied to a vessel containing the cocoa beans or products derived therefrom. For example, the aeration may be carried out with a flow rate of the oxygen-containing gas of from 0.01 to 0.1 m³/(hr·kg of cocoa beans or products derived therefrom) or from 0.03 to 0.08 m³/(hr·kg), at an aeration time of from 30 to 60 minutes, such as about 30 minutes, at a pressure of from 0 to 3 bar, or from 1 to 2 bar, and at a temperature of from ambient temperature to 150° C., from 30 to 120° C., from 50 to 100° C., from 70 to 98° C. or from 90 to 95° C. In an embodiment, the aeration step is carried out at 95° C.

In some further embodiments, the alkalization may be concluded by applying vacuum to the vessel containing the alkalized and optionally aerated cocoa beans or products derived therefrom. The vacuum may be approximately 0.9 bar. The vacuum may be applied for a period of time of from 15 minutes to 6 hours, from 30 minutes to 5 hours or from 45 minutes to 4 hours. In some embodiments the vacuum is applied for a period of time of from 25 to 45 minutes. The temperature within the vessel during the vacuum step may be from ambient temperature to 150° C., from 30 to 120° C. or from 50 to 100° C. In an embodiment, the temperature within the vessel during the vacuum drying step is 95° C. The vacuum drying step is typically carried out such that the moisture content of the cocoa beans, or products derived therefrom, is in the desired range. For example, the vacuum step may be carried out such that the moisture content of the cocoa beans, or products derived therefrom, resulting from this stage is adjusted to the moisture content required for the roasting process i.e. in the range of from 15 to 30 wt. %, from 15 to 22 wt. %, or from 15 to 20 wt. %.

In some embodiments, the water content of the cocoa beans, or products derived therefrom, at the end of the alkalization may be from 10 to 25% or from 15 to 20% (w/w).

Conveniently, some or all of the steps of the alkalization may be carried out in the same equipment.

In addition, to the alkalization, the process for the production of the cocoa powder may additionally comprise a roasting step, in which the cocoa beans or products derived therefrom are roasted by indirect heating. Different processes for roasting cocoa beans or products derived therefrom will be well-known to those skilled in the art. The heat may be transferred onto the beans or products derived therefrom by means of the heated walls of the roasting equipment. For example, the beans or products derived therefrom may be contained in a vessel which is heated from the exterior, such as by means of a steam jacket or with (electrically) heated air or combustion gases from burning fuels. The roasting equipment may be a conventional drum roaster, such, as available from G. W. Barth. The cocoa beans or products derived therefore used in the production of the cocoa powder may have, a moisture content of from 15 to 22 wt %, or from 15 to 20 wt %. The moisture content of the beans can be determined by drying and measuring the weight prior to and after drying. The roasting step may be carried out before or after the alkalization step. In a preferred embodiment, the roasting step is carried out after the alkalization step.

Following the roasting process, an optional de-shelling step may be included for removing the shells from the roasted cocoa beans. The resulting roasted nibs may then be milled (ground) to produce cocoa liquor comprising cocoa solids (cocoa powder) and cocoa butter, in the conventionally known manner. The cocoa liquor may be used as such in the manufacture of chocolate-flavoured products. Alternatively, using conventional processing such as pressing, the cocoa powder can be separated from the cocoa butter. The cocoa powder typically is produced in two grades, containing either 10-12 wt. % or 20-22 wt. % of fat (cocoa butter), but other grades of cocoa powder, such as “fat-free” cocoa powder (<2 wt. % fat), may be produced in accordance with conventionally known processes.

Thus, in some embodiments, the process for the production of cocoa powder comprises:

an optional pre-treatment step;
alkalization, wherein an alkalizing salt is added to the cocoa beans, or products derived therefrom;
an optional aeration step;
an optional vacuum drying step;
an optional roasting step;
an optional de-shelling step;
an optional milling step; and
an optional pressing step,
wherein the pre-treatment, aeration, vacuum drying, roasting, de-shelling, milling and pressing are carried out as described above, and
wherein the alkalizing salt is selected from:
more than 2 wt % sodium hydroxide;
more than 2 wt % sodium hydroxide and from 5 to 10 wt % potassium carbonate;
more than 2 wt % sodium hydroxide and at least 10 wt % ammonium carbonate; or
more than 2 wt % sodium hydroxide, at least 3 wt % potassium hydroxide and at least 10 wt % ammonium carbonate.

In some embodiments the process includes all of the optional steps listed above.

Thus, in one embodiment of the present invention, there is provided a process for the production of cocoa powder, comprising the steps of:
pre-treating cocoa beans or products derived therefrom by heating the cocoa beans or products derived therefrom in the presence of water, optionally under pressure;
alkalization, wherein an alkalizing salt is added to the cocoa beans, or products derived therefrom, in the absence of iron;
roasting the cocoa beans or products derived therefrom;
optionally de-shelling the roasted cocoa beans to obtains roasted cocoa nibs; and
milling the roasted nibs to produce cocoa liquor comprising cocoa powder and cocoa butter.

It will be understood that, in the embodiment described above, the alkalization, the roasting and, if present, the de-shelling step may be carried out in any order. For example, the roasting step may be carried out prior to the alkalization, and the de-shelling step may be carried out either before or after the roasting step. The alkalization may optionally include aeration and/or vacuum steps.

The processes of the present invention may be used to produce HFC powder and/or standard black cocoa powder. As used, herein, HFC powder is understood to be a black cocoa powder which has a more intense flavour and a darker colour than standard black cocoa powder. One way of making HFC powder is described in European patent application no. EP 2241190, which describes a particular roasting and holding process that results in black cocoa powder having enhanced flavour properties. In a particular embodiment, the processes of the invention are used to produce HFC powder. Since HFC powder has a more intense flavour, it allows the use of less cocoa powder in confectionery products and thus is more cost effective.

According to a third aspect of the invention, there is provided a process for the production of cocoa powder, comprising alkalizing cocoa beans or products derived therefrom in the presence of an ammonium salt and/or a potassium salt, and optionally in the presence of an iron salt,

wherein, the iron salt, when present, is present at a concentration of no more than 2 wt % and
wherein the total concentration of ammonium salt and/or potassium salt is more than 8 wt %, based on the weight of the cocoa beans or products derived therefrom.

In some embodiments, the iron salt, when present, is present at a concentration of no more than 1.5 wt %, no more than 1 wt %, no more than 0.8 wt %, no more than 0.6 wt %, no more than 0.4 wt % or no more than 0.2 wt %, based on the weight of the cocoa beans or products derived, therefrom. In some embodiments the iron salt, when present, is not iron saccarate. In further embodiments no iron salt is present, i.e. the concentration of the iron salt is 0 wt %.

In some embodiments, the total concentration of ammonium salt and/or potassium salt is more than 10 wt %, more than 12 wt %, more than 14 wt %, more than 16 wt % or more than 18 wt %, based on the weight of cocoa beans or products derived therefrom.

The relative proportions of ammonium salt to potassium salt may be from 0:100 to 100:0. Therefore, in some embodiments, the concentration of ammonium salt is more than 8 wt %, more than 10 wt %, more than 12 wt %, more than 14 wt %, more than 16 wt % or more than 18 wt %. In some embodiments the concentration of ammonium salt is less than 15 wt %, less than 12 wt %, less than 10 wt %, less than 8 wt %, less than 5 wt %, less than 3 wt %, less than 2 wt %, less than 1 wt % or 0 wt %. In other embodiments, the concentration of potassium salt is more than 2 wt %, more than 4 wt %, more than 5 wt %, more than 8 wt % or more than 10 wt %. The concentration of potassium salt may be less than 15 wt %, less than 12 wt %, less than 10 wt %, less than 8 wt %, less than 5 wt %, less than 3 wt %, less than 2 wt %, less than 1 wt % or 0 wt %, based on the weight of the cocoa beans or products derived therefrom.

In some embodiments, the potassium salt is potassium hydroxide. In some embodiments, the potassium salt is potassium carbonate. In some embodiments, the ammonium salt is ammonium carbonate.

According to a fourth aspect of the invention, there is provided a cocoa powder producible in accordance with the process of the first, second or third aspects of the invention.

In some embodiments of the fourth aspect of the invention, the powder is producible by a process in which the alkalization step uses one of the following alkalizing agents:
sodium hydroxide (e.g. at a concentration of more than 2 wt %);
sodium hydroxide (e.g. at a concentration of more than 2 wt %) and potassium carbonate (e.g. at a concentration of from 5 to 10 wt %);
sodium hydroxide (e.g. at a concentration of more than 1 wt %) and potassium carbonate (e.g. at a concentration of less than 1 wt %);
sodium hydroxide (e.g. at a concentration of from 1 to 4 wt %, such as 2.0 to 2.5 wt %) and ammonium carbonate (e.g. at a concentration of from 3 to 12 wt %, such as from 5 to 7 wt %);
sodium hydroxide (e.g. at a concentration of more than 2 wt %), ammonium carbonate (e.g. at a concentration of at least 10 wt %);
sodium hydroxide (e.g. at a concentration of more than 2 wt %), potassium hydroxide (e.g. at a concentration of at least 3 wt %) and ammonium carbonate (e.g. at a concentration of at least 10 wt %).
sodium hydroxide (e.g. at a concentration of from 2.0 to 2.5 wt %), potassium carbonate (e.g. at a concentration of from 0.8 to 1.5 wt %) and ammonium carbonate (e.g. at a concentration of from 3 to 12 wt %).

According to a fifth aspect of the invention, there is provided a black cocoa powder comprising sodium hydroxide, potassium carbonate or potassium hydroxide, or any combination thereof, wherein the cocoa powder contains no ammonia.

According to a sixth aspect of the invention, there is provided a black cocoa powder comprising sodium and/or potassium hydroxide wherein the cocoa powder contains no ammonia.

In some embodiments of the fourth, fifth and sixth aspects of the invention, the cocoa powder has an “L” value of less than 10, less than 5, less than 4, less than 3.5, less than 3 or less than 2, as measured using the intrinsic colour test described above. In some embodiments the cocoa powder has an “L” value of greater than 1.0, greater than 2.0 or greater than 3.0, as measured using the intrinsic colour test described above.

In some embodiments, the cocoa powder has an “a” value of less than 4.5, less than 4, less than 3, less than 2.5 or less than 2. In some embodiments, the cocoa powder has an “a” value of greater than 0, greater than 0.5 or greater than 1.0, as measured using the intrinsic colour test described above.

In some embodiments, the cocoa powder has a “b” value of less than 4, less than 3 or less than 2. In some embodiments, the cocoa powder has a “b” value of greater than 0, greater than 0.5 or greater than 1.0, as measured using the intrinsic colour test described above.

In some embodiments, the cocoa powder comprises less than 3 wt %, less than 2.5 wt % or less than 2 wt % potassium.

In some embodiments, the cocoa powder comprises from 1 to 4 wt % sodium, from 2 to 3 wt % sodium or from 2.5 to 2.8 wt % sodium.

In some embodiments, the cocoa powder comprises from 0.01 to 0.5 wt % iron, or from 0.05 to 0.3 wt % iron. In other embodiments, the cocoa powder contains no iron.

In some embodiments, the cocoa powder comprises from 8 to 20% fat, from 10 to 15% fat or from 11 to 13% fat.

In some embodiments, the cocoa powder comprises from 1 to 5% water, from 1.5 to 4% water, from 2 to 4% water or from 2.5 to 3.5% water.

In some embodiments, the cocoa powder comprises no more than 15%, no more than 14% or no more than 12% ash. In some embodiments, the cocoa powder comprises from 11 to 14% ash.

In some embodiments the cocoa powder has a pH of more than 8.5.

According to a seventh aspect of the invention, there is provided a confectionery product comprising cocoa powder in accordance with the fourth or fifth aspect of the invention.

Confectionery products comprising the cocoa powder may include cakes, biscuits, biscuit dough, chocolate compositions including milk and dark chocolate, ice-cream, compound chocolate, beverages, spreads, dip, sauces or like products. In a particular embodiment, the confectionery product is a chocolate composition. In another embodiment, the confectionery product is a biscuit, or biscuit dough from which biscuits can be made.

In particular embodiments, the confectionery product comprises HFC powder made in accordance with the present invention. The confectionery product may comprise no more than 15%, no more than 10%, no more than 8% or no more than 5% HFC powder. The use of HFC powder is advantageous in that much less HFC powder is required in the confectionery product than if standard black cocoa powder is used, due to the intense flavour of HFC powder.

### DETAILED DESCRIPTION OF CERTAIN EMBODIMENTS

Embodiments of the invention will now be described by way of example and with reference to the figure, in which:

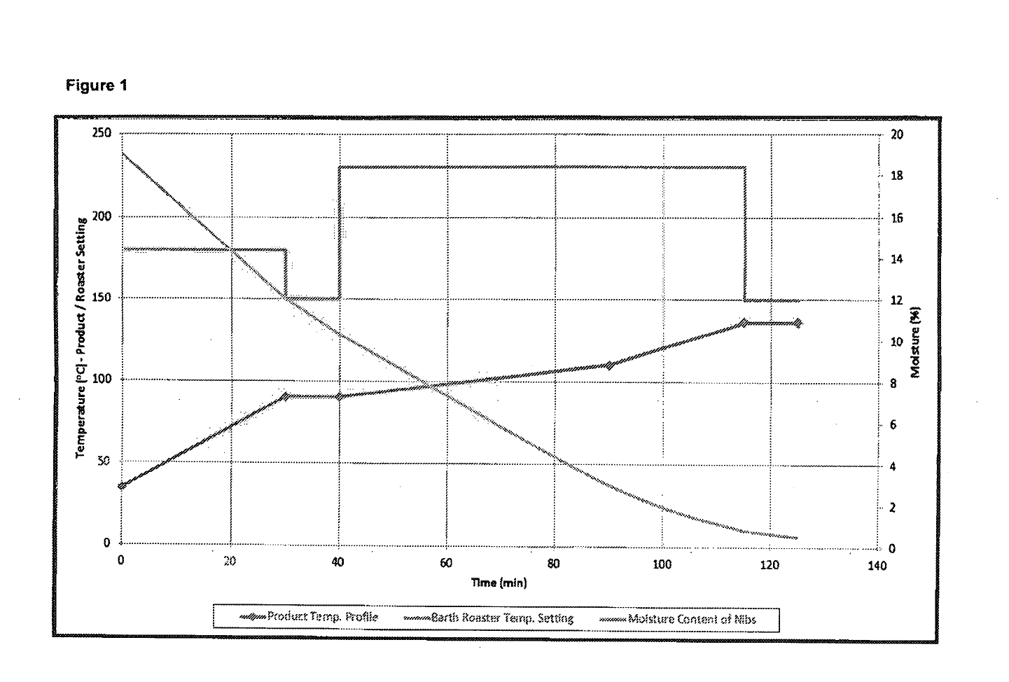

FIG. 1 shows an exemplary roasting profile;

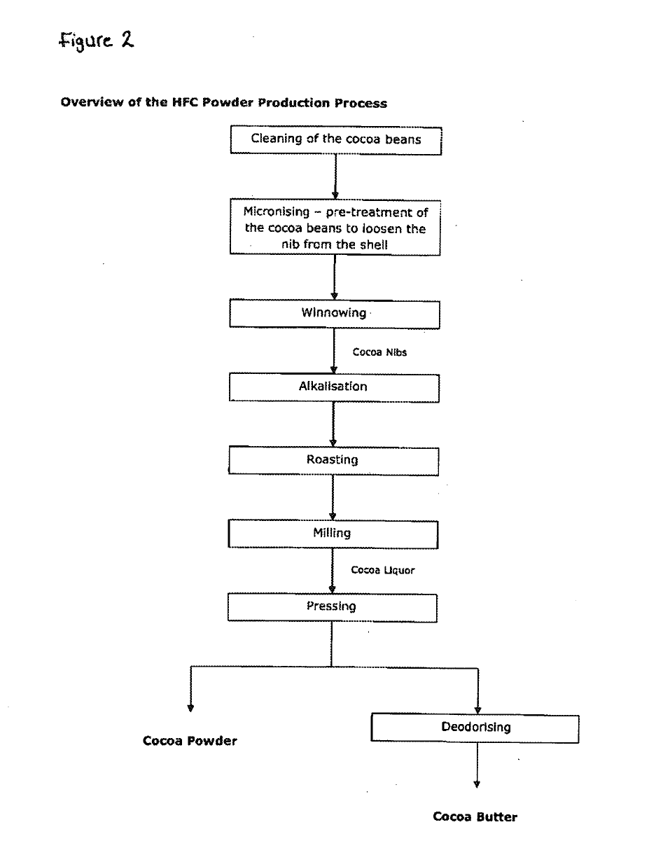

FIG. 2 shows an overview of the HFC powder production process; and

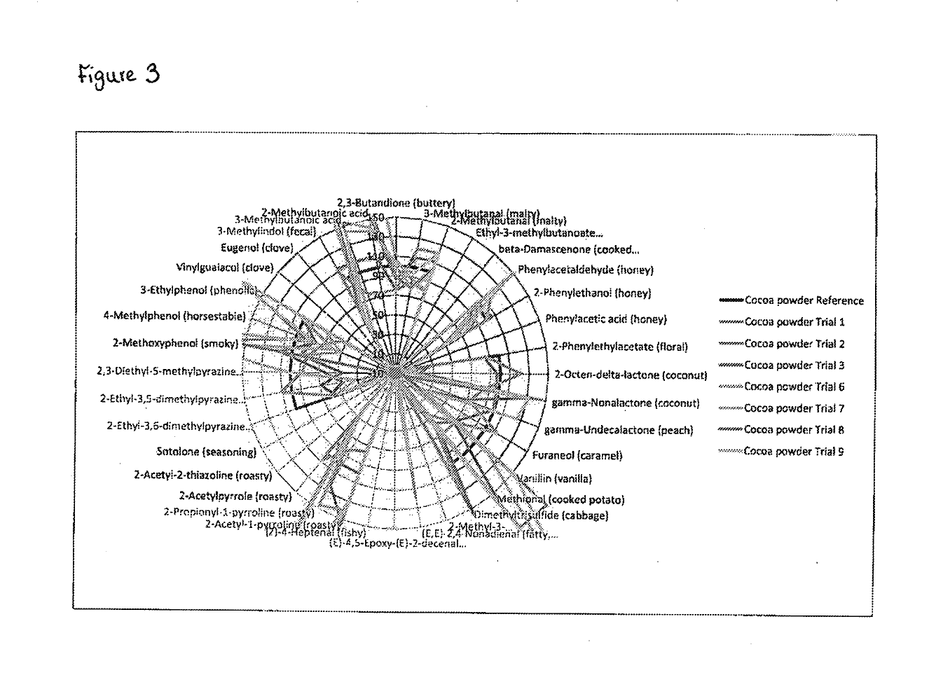

FIG. 3 shows the results of potent aroma compounds (PAC) analysis of cocoa powders produced in accordance with embodiments of the present invention.

### METHODOLOGY

All samples were produced using Ivory Coast cocoa nibs which had been cleaned and winnowed.

### Pre-Treatment:

The raw cocoa nibs (15 kg) were pre-treated in an alkalization vessel by adding 7 wt % water, blending the cocoa nibs and the water for 60 minutes at 95° C.

### Alkalization:

The pre-treated nibs were then subjected to an alkalization treatment by adding alkalizing salts (alkalizing agents) including sodium hydroxide, potassium hydroxide, potassium carbonate and ammonium carbonate in various combinations. The nibs were treated with steam in a pressurisation phase, followed by an optional aeration phase. A vacuum was then applied depending on the moisture content of the nibs. Details of the pressure, temperature and time conditions are given in each example.

### Roasting:

The nibs were removed from the alkalization vessel and then placed in a drum roaster for roasting. The roasting profile used was the same as for the ‘standard’ HFC process detailed in US Patent Application No. US2010/0266741 A1, and its methods are incorporated herein by reference. A summary of the roasting profile is shown in FIG. 1.

After roasting, the nibs were milled and the resulting cocoa liquor was pressed to remove cocoa butter, leaving HFC cocoa powder. The HFC cocoa powder was used to prepare Oreo biscuits.

### EXAMPLES

### Removal of Iron Salt

The following examples relate to the elimination of iron salts altogether from the process. Comparative Example 1a shows the standard recipe for HFC powder production. Comparative Example 1b shows the standard alkalisation process conditions. Example 2 shows the same recipe without addition of iron salts. Example 3 shows the recipe without iron or ammonia salts. A summary of the roasting profile is shown in FIG. 1. An overview of the HFC powder production process is shown in FIG. 2.

### Comparative Example 1a

| | Reference (Standard HFC) | | |
|---|---|---|---|
| Ingredient | Form | Concentration | Amount (kg) |
| Water (pre-treatment) | — | 7% | 1.07 |
| Iron saccharate | solid | 1.4% | 0.2 |
| Ammonium carbonate | solid | 12% | 1.8 |
| Sodium hydroxide (NaOH) | 10% soln. | 2.4% | 0.36 |
| Potassium hydroxide (KOH) | — | — | — |
| Potassium carbonate (K₂CO₃) | — | — | — |
| Total water content | | | 4.31 |

### Comparative Example 1b

Reference
(Standard HFC)

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | 1 | 95 |
| Ammonium carbonate addition | 1 | 95 |
| Potassium carbonate addition | — | — |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | 90* | 95 |

*Vacuum drying time required is dependent on moisture content. Standard time required is typically 20-45 minutes. The increased vacuum drying time needed to achieve target nibs moisture content indicated a fault in the vessel. It was not felt that this fault would have a significant effect on either the colour or flavour development in the finished cocoa powder as this step is only present to remove excess moisture.

### Example 2

| | Removal of Iron Salt only | | |
|---|---|---|---|
| Ingredient | Form | Concentration | Amount (kg) |
| Water (pre-treatment) | — | 7% | 1.07 |
| Iron saccharate | — | — | — |
| Ammonium carbonate | solid | 12% | 1.8 |
| Sodium hydroxide (NaOH) | 10% soln. | 2.4% | 0.36 |
| Potassium hydroxide (KOH) | — | — | — |
| Potassium carbonate (K₂CO₃) | — | — | — |
| Total water content | | | 4.31 |

Removal of
Iron Salt only

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | 1 | 95 |
| Potassium carbonate addition | — | — |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | ~180* | 95 |

### Example 3

| | Removal of Iron Salt and Ammonium | | |
|---|---|---|---|
| | Carbonate | | |
| Ingredient | Form | Concentration | Amount (kg) |
| Water (pre-treatment) | — | 7% | 1.07 |
| Iron saccharate | — | — | — |
| Ammonium carbonate | — | — | — |
| Sodium hydroxide (NaOH) | 10% soln. | 2.4% | 0.36 |
| Potassium hydroxide (KOH) | — | — | — |
| Potassium carbonate (K₂CO₃) | — | — | — |
| Total water content | | | 4.31 |

Removal of Iron Salt and
Ammonium Carbonate

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | — | — |
| Potassium carbonate addition | — | — |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | ~220* | 95 |

### Example 4

| | Removal of Iron Salt and Replacement | | |
|---|---|---|---|
| | with KOH | | |
| Ingredient | Form | Concentration | Amount (kg) |
| Water (pre-treatment) | — | 7% | 1.07 |
| Iron saccharate | — | — | — |
| Ammonium carbonate | solid | 12% | 1.8 |
| Sodium hydroxide (NaOH) | 20% soln. | 2.4% | 0.36 |
| Potassium hydroxide (KOH) | 25% soln. | 3.36% | 0.504 |
| Potassium carbonate (K₂CO₃) | — | — | — |

| | |
|---|---|
| Total water content | 4.022 |

Removal of Iron Salt and
Replacement with KOH

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | 1 | 95 |
| Potassium hydroxide addition | 1 | 95 |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | ~180* | 95 |

It was found that the cocoa powders produced in accordance with Examples 2 and 4 compared well in terms of appearance to the HFC reference sample. The powder produced by Example 3 was noticeably lighter in appearance. Colour analysis of the cocoa powders was performed using a spectrocolorimeter at the Kraft. Foods Glocal Science Centre in Reading (UK), according to the intrinsic colour (dispersion) test described above, which was carried out at room temperature. The following parameters were measured:
L, brightness (scale from 0=dark to 100=white)
a, red-green scale (+a for red; −a for green; the higher the numerical value, the more intensive the colour impression)
b, yellow-blue scale (+b for yellow; −b for blue; the higher the numerical value, the more intensive the colour impression).

The results of the analysis are shown in Table A.

TABLE A
Results of colour analysis

| | | | | | | Method |
|---|---|---|---|---|---|---|
| | | Sample | | | | un- |
| | | Reference | Example 2 | Example 3 | Example 4 | certainty |
| Colour | L | 2.64 | 2.87 | 4.62 | 1.91 | ±1.0 |
| | a | 1.01 | 1.46 | 3.97 | 0.83 | ±0.5 |
| | b | 0.93 | 1.34 | 3.21 | 0.71 | ±0.5 |

The data shows that recipe and process used in Example 4 gave the darkest cocoa powder (lowest L value), while the recipe and process of Example 2 gave a powder which matched most closely with the reference sample.

It was found by informal sensory assessment that the cocoa samples produced by Examples 2 and 3 compared favourably in terms of flavour profile to the reference sample.

Potent aroma compounds (PAC) analysis was also performed on the powder samples. The results of this analysis are shown in FIG. 3. It was found that the cocoa powders of Examples 2 and 3 were quite similar to the HFC reference powder, while the data for the cocoa powder of Example 4 showed significant differences to the reference for a number of compounds. For the majority of these compounds, a lower concentration than the reference was detected.

Replacement of Ammonium Carbonate with Potassium Carbonate

The effect of adding potassium carbonate as a replacement of ammonium carbonate was investigated. Potassium carbonate was selected since it has regulatory approval. Examples 5 to 8 show recipes in which the ammonium carbonate of the standard process is replaced by potassium carbonate. Varying concentrations of potassium carbonate were trialled to investigate the effect of this compound of the appearance and flavour profile of the powder. In each case 15 kg of raw cocoa nibs were used.

The alkalisation process used in each trial is also shown. As in Examples 2-4, the standard roasting profile (FIG. 1) was used. In Example 8, the recipe was the same as that used in Example 5, but the aeration phase of the alkalisation step was removed. The standard alkalisation process is shown in comparative Example 1c.

### Comparative Example 1c

Reference (Standard HFC)

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | 1 | 95 |
| Ammonium carbonate addition | 1 | 95 |
| Potassium carbonate addition | — | — |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | 25-45* | 95 |

### Example 5

### Replacement of Ammonium Carbonate with Potassium Carbonate

| Ingredient | Form | Concentration | Amount (kg) |
|---|---|---|---|
| Water (pre-treatment) | — | 7% | 1.07 |
| Iron saccharate | — | — | — |
| Ammonium carbonate | — | — | — |
| Sodium hydroxide (NaOH) | 10% soln. | 2.4% | 0.36 |
| Potassium carbonate (K₂CO₃) | solid | 7 | 1.07 |
| Process condition changes | — | — | — |
| Total water content | | | 4.31 |

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | — | — |
| Potassium carbonate addition | 1 | 95 |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | 150* | 95 |

### Example 6

### Replacement of Ammonium Carbonate with Potassium Carbonate at a Higher Level

| Ingredient | Form | Concentration | Amount (kg) |
|---|---|---|---|
| Water (pre-treatment) | — | 7% | 1.07 |
| Iron saccharate | — | — | — |
| Ammonium carbonate | — | — | — |
| Sodium hydroxide (NaOH) | 10% soln. | 2.4% | 0.36 |
| Potassium carbonate (K₂CO₃) | solid | 10 | 1.5 |
| Process condition changes | — | — | — |
| Total water content | | | 4.31 |

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammoniurn carbonate addition | — | — |
| Potassium carbonate addition | 1 | 95 |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | 120* | 95 |

### Example 7

### Replacement of Ammonium Carbonate with Potassium Carbonate at a Lower Level

| Ingredient | Form | Concentration | Amount (kg) |
|---|---|---|---|
| Water (pre-treatment) | — | 7% | 1.07 |
| Iron saccharate | — | — | — |
| Ammonium carbonate | — | — | — |
| Sodium hydroxide (NaOH) | 1.0% soln. | 2.4% | 0.36 |
| Potassium carbonate (K₂CO₃) | solid | 5.35 | 0.803 |
| Process condition changes | — | — | — |

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | — | — |
| Potassium carbonate addition | 1 | 95 |
| Sodium hydroxide addition | 1 | 95 |
| Pressurisation phase (2.5 bar) | 90 | 140 |
| Air injection (to 2 bar pressure) | 30 | 95 |
| Vacuum drying phase (~−0.9 bar) | ~300* | 95 |

### Example 8

### Replacement of Ammonium Carbonate with Potassium Carbonate

| Ingredient | Form | Concentration | Amount (kg) |
|---|---|---|---|
| Water (pre-treatment) | — | 7% | 1.07 |
| Iron saccharate | — | — | — |
| Ammonium carbonate | — | — | — |
| Sodium hydroxide (NaOH) | 10% soln. | 2.4% | 0.36 |
| Potassium carbonate (K₂CO₃) | solid | 7 | 1.07 |
| Total water content | | | 4.022 |

| | Time | Jacket Temp. |
|---|---|---|
| Step | (mins) | (° C.) |
| Cocoa nibs addition | Initial | 95 |
| Water addition | Initial | 95 |
| Water pre-treatment phase | 60 | 95 |
| Iron salt addition | — | — |
| Ammonium carbonate addition | — | — |
| Potassium carbonate addition | 1 | 95 |
| Sodium hydroxide addition | 1 | 95 |
| Pressurisation phase (2.5 bar) | 90 | 140 |
| Air injection (to 2 bar pressure) | — | — |
| Vacuum drying phase (~−0.9 bar) | ~240* | 95 |

The cocoa powder produced in accordance with the recipe and process of Example 5 was found to be darker in colour than both the HFC reference powder (D11-B) and the powder of Example 3. Colour analysis of the cocoa powders of Examples 5-8 is shown in Table B.

TABLE B

| | | Sample | | | | | Method |
|---|---|---|---|---|---|---|---|
| | | Reference | Ex. 5 | Ex. 6 | Ex. 7 | Ex. 8 | uncertainty |
| Colour | L | 2.64 | 1.87 | 2.27 | 2.87 | 3.03 | ±1.0 |
| | a | 1.01 | 0.52 | 0.44 | 0.79 | 1.26 | ±0.5 |
| | b | 0.93 | 0.21 | 0.28 | 0.62 | 0.95 | ±0.5 |

From this data it can be seen that, in terms of appearance, all of the samples are considered acceptable when compared to the reference. It was also apparent that the cocoa samples contained a slight reddish hue compared to the browner colour of the reference. Removal of the aeration step from the alkalisation process of Example 8 was found to result in no significant differences in any of the L, a or b values.

PAC analysis was carried out on the cocoa samples. It was found that the cocoa powders produced in Examples 5 to 8 were more different to the reference sample in terms of flavour profile than the powders produced by Examples 2 to 4.

### Sensory Assessment

A number of the trial powder samples were selected for an informal sensory assessment. The method used was a degree of difference (DoD) test on a 7-point scale (where 1=close to reference, 7=far away from the reference). All samples were assessed blind. The results of the assessment are shown in Table C.

TABLE C

| | Reference | Ex. 2 | Ex. 5 | Ex. 6 | Ex. 7 |
|---|---|---|---|---|---|
| Mean DoD | 1.6 | 4.2 | 7.0 | 7.0 | 7.4* |

*Although a 7-point scale is used, Example 7 was thought to be so different that it was more appropriate to score the sample on an 8-point scale. These findings support the data from the PAC analysis. As shown by these results, the cocoa powder of Example 2 was noticeably closer to the reference sample than Examples 5, 6 and 7.

### Examples 9-15

### The following examples relate to alkalization in the absence of iron salts and ammonium carbonate

| | Concentration (wt %) | | | | | | |
|---|---|---|---|---|---|---|---|
| Ingredient | Ex 9 | Ex 10 | Ex 11 | Ex 12 | Ex 13 | Ex 14 | Ex 15 |
| Water (pre-treatment) | 7 | 7 | 7 | 7 | 7 | 7 | |
| Iron saccharate | — | — | — | — | — | — | — |
| Ammonium carbonate | — | — | — | — | — | — | — |
| ((NH₄)₂CO₃) | | | | | | | |
| Ammonium hydroxide | — | — | — | — | — | — | — |
| (NH₄OH) | | | | | | | |
| Ammonium | — | — | — | — | — | — | — |
| bicarbonate | | | | | | | |
| (NH₄HCO₃) | | | | | | | |
| Sodium carbonate | — | — | — | — | — | — | — |
| (Na₂CO₃) | | | | | | | |
| Sodium bicarbonate | — | — | — | — | — | — | — |
| (NaHCO₃) | | | | | | | |
| Sodium hydroxide | 3.5 | 5.2 | 10 | — | — | — | 2.8 |
| (NaOH) | | | | | | | |
| Potassium hydroxide | — | — | — | 2.0 | 4.5 | 8.2 | |
| (KOH) | | | | | | | |
| Potassium carbonate | — | — | — | — | — | — | 2.5 |
| (K₂CO₃) | | | | | | | |
| Potassium bicarbonate | — | — | — | — | — | — | |
| (KHCO₃) | | | | | | | |
| Total alkalizing salt | 3.5 | 5.2 | 10 | 2.0 | 4.5 | 8.2 | 5.3 |

### Examples 16-19

Chocolate compositions comprising HFC powder produced in accordance with the present invention may be made according to the recipes provided in the following examples. Comparative example 16 is a chocolate recipe using standard black cocoa powder. As is shown by examples 16-19, HFC powder produced in accordance with the invention allows the use of significantly less cocoa powder.

| | Amount (wt % of total) | | | |
|---|---|---|---|---|
| | Comp. | | | |
| | Ex. 16 | Example 17 | Example 18 | Example 19 |
| | (standard | (HFC | (HFC | (HFC |
| | black cocoa | powder of | powder) of | powder of |
| Ingredient | powder) | Example 2) | Example 3) | Example 6) |
| Sweetener (e.g. | 45 | 57 | 47 | 53 |
| sucrose, | | | | |
| artificial | | | | |
| sweeteners or | | | | |
| mixture | | | | |
| thereof) | | | | |
| Cocoa butter | 32 | 23 | 35 | 32 |
| Cocoa powder | 10 | 7 | 5 | 3 |
| Milk solids | 12 | 12 | 12 | 11 |
| Emulsifier | 1 | 1 | 1 | 1 |

### Examples 20-21

The following examples relate to biscuit dough recipes comprising cocoa powder. Comparative example 20 is a recipe using standard black cocoa powder, while example 21 uses HFC powder produced in accordance with the present invention.

Amount (wt % of total)

| | | Example 21 |
|---|---|---|
| | Comp Ex. 20 | (using HFC |
| | (Standard black | powder of |
| Ingredient | cocoa powder) | Example 2) |
| Flour | 40-70 | 40-70 |
| Cocoa powder | 5-10 | 1-5 |
| Sugar/sweetener | 10-30 | 10-30 |
| Fat | 10-25 | 10-25 |
| Hydrocolloid | 0-2 | 0-2 |
| Emulsifier | 0-2 | 0.1-2 |
| Flavourings/preservatives/ | 0-5 | 0-5 |
| other minor ingredients | | |

1. A process for the production of black cocoa powder, said process comprising an alkalization step in which an alkalizing salt is added to cocoa beans, or products derived therefrom, in the absence of iron, wherein the alkalizing salt consists of a mixture of ammonium carbonate and sodium hydroxide and either (i) the amount of sodium hydroxide is from 2.0 to 2.5 wt % and/or (ii) the amount of ammonium carbonate is from 5 to 7 wt %.

2-3. (canceled)

4. A process for the production of black cocoa powder, said process comprising an alkalization step in which an alkalizing salt is added to cocoa beans, or products derived therefrom, in the absence of iron, wherein the alkalizing salt consists of a mixture of ammonium carbonate, sodium hydroxide and potassium hydroxide.

5. The process according to claim 4, wherein the amount of sodium hydroxide added to the cocoa beans, or products derived therefrom, is from 2.0 to 2.5 wt %.

6. The process according to claim 4, wherein the amount of potassium carbonate added to the cocoa beans, or products derived therefrom, is from 0.8 to 1.5 wt %.

7. (canceled)

8. The process according to claim 2, wherein the alkalizing salt comprises ammonium carbonate in an amount of no more than 10 wt %.

9-14. (canceled)

15. The process according to claim 2, wherein the amount of potassium hydroxide added to the cocoa beans, or products derived therefrom, is at least 1 wt %.

16-23. (canceled)

24. The process according to claim 1, wherein the total amount of alkalizing salts added to the cocoa beans, or products derived therefrom, is from 1 to 20 wt %.

25. The process according to claim 1, wherein the cocoa powder is HFC powder.

26. A process for the production of cocoa powder, said process comprising an alkalizing step in which an alkalizing salt is added to cocoa beans or products derived therefrom, wherein sodium hydroxide is added as the sole alkalizing salt in an amount which is more than 2 wt %, based on the weight of the cocoa beans or products derived therefrom.

27. A process for the production of cocoa powder, comprising alkalizing cocoa beans or products derived therefrom in the presence of an ammonium salt and/or a potassium salt, and optionally in the presence of an iron salt, wherein the iron salt, when present, is present at a concentration of no more than 2 wt % and wherein the total concentration of ammonium salt and/or potassium salt is more than 8 wt %, based on the weight of the cocoa beans or products derived therefrom.

28. The process according to claim 27, wherein the iron salt, when present, is not iron saccharate.

29. The process according to claim 27, wherein no iron salt is present.

30. The process according to claim 27, wherein the concentration of ammonium salt is less than 10 wt %.

31. The process according to claim 27, wherein the concentration of potassium salt is less than 8 wt %.

32. The process according to claim 27, wherein the potassium salt is potassium hydroxide.

33. The process according to claim 27, wherein the potassium salt is potassium carbonate.

34. The process according to claim 27, wherein the cocoa powder is HFC powder.

35-45. (canceled)

46. The process according to claim 2, wherein the total amount of alkalizing salts added to the cocoa beans, or products derived therefrom, is from 1 to 20 wt %.

47. The process according to claim 2, wherein the cocoa powder is HFC powder.
